(19) United States
(12) Patent Application Publication
(10) Pub. No.: US 2008/0175632 A1
(43) Pub. Date: Jul. 24, 2008

(54) FIXING UNIT AND IMAGE FORMING APPARATUS USING THE SAME

(75) Inventor: Hiroshi Ota, Ohta-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/456,992

(22) Filed: Jul. 12, 2006

(51) Int. Cl. G03G 15/20

(52) U.S. Cl. 399/327

(57) ABSTRACT

There is provided an image forming apparatus in which abrasion powder produced from a resin bush of a heat roller of a fixing unit is prevented from flying onto the heat roller and the like, an image defect is not caused, and its life is long. A fixing unit 100 of an image forming apparatus of an embodiment of the invention includes a heat roller 10 and a press roller 20 rotating in a state where they are in parallel contact with each other. The heat roller includes a paper passing area 11 at a center portion, paper non-passing areas 12 and 13 at both outsides thereof, and support areas 14 and 15 where the heat roller is rotatably supported by resin bushes 18 and 19, and includes plate-shaped cleaning plates 16 and 17 outer fringes of which come in contact with a surface of the heat roller in the paper non-passing area and which scrape abrasion powder flying onto the paper non-passing areas.

### BACKGROUND OF THE INVENTION

1. Field of the Invention

The present invention relates to a fixing unit and an image forming apparatus using the same, and particularly to a fixing unit in which a press roller and a heat roller cooperate with each other to feed a print sheet, which is sent to a paper passing area of the heat roller, through the area while pressing it against the heat roller, so that a toner image formed on the print sheet is fixed to the print sheet, and an image forming apparatus provided with the same.

2. Description of the Related Art

In a fixing unit of a conventional image forming apparatus, in the case of a low speed machine or a middle speed machine, or in the case of an inexpensive model, there is known one in which for reducing the cost, a heat-resistant resin bush is used instead of bearings for supporting a heat roller.

The resin bush used for the fixing unit of the foregoing conventional image forming apparatus is worn away with the passage of time, and as a result, abrasion powder is scattered from the resin bush. The abrasion powder scattered as stated above flies to the heat roller, a press roller or the like and is adhered thereto, and causes an image defect, and consequently, the use life of the fixing unit is shortened. Incidentally, JP-A-2004-144833 is known as relevant to a technique of preventing the shaving of an end of a roller.

### SUMMARY OF THE INVENTION

The invention has been made to solve the foregoing problems, and it is an object to provide a fixing unit in which abrasion powder produced from a resin bush of the fixing unit is prevented from flying onto a heat roller, a press roller or the like and is reduced, an image defect is not caused, and its use life is long, and an image forming apparatus using the same.

In order to solve the foregoing problems, a fixing unit according to an aspect of the invention includes a heat member that has a heater and has both ends rotatably supported by resin bushes, a press member that cooperates with the heat member to feed a transfer member, which is sent to the heat member and on which a toner image is formed, while pressing it against the heat member and fixes the toner image to the transfer member, and a cleaning member that comes in contact with a surface of the heat member outside an area of the heat member through which the transfer member is fed and scrapes an attachment attached on the surface of the heat member.

Besides, a fixing unit according to an aspect of the invention includes heat means having a heater and both ends rotatably supported by resin bushes, press means for fixing a toner image to a transfer member by cooperating with the heat means to feed the transfer member, which is sent to the heat means and on which the toner image is formed, while pressing it against the heat means, and cleaning means in contact with a surface of the heat member outside an area of the heat means through which the transfer member is fed and for scraping an attachment attached on the surface of the heat member.

Besides, a cleaning method of a fixing unit according to an aspect of the invention includes rotatably supporting both ends of a heat member by resin bushes, fixing a toner image to a transfer member by a press member that cooperates with the heat member to feed the transfer member, which is sent to the heat member and on which the toner image is formed, while pressing it against the heat member, and scraping an attachment attached on a surface of the heat member by bringing a cleaning member into contact with the surface of the heat member outside an area of the heat member through which the transfer member is fed.

Since the invention is constructed as described above, even if abrasion powder is produced from the resin bush with the passage of time, the cleaning member scrapes the incoming abrasion powder in a paper non-passing area, it is possible to prevent the abrasion powder from scattering to a paper passing area inside of the paper non-passing area.

### DESCRIPTION OF THE DRAWINGS

FIG. 1 is a side view schematically showing embodiment 1 of the invention.

FIG. 2 is a view in which a heat roller shown in FIG. 1 is seen from the outlet side of a print sheet.

FIG. 3 is a view for explaining a suitable attachment position of a cleaning plate shown in FIG. 1 and FIG. 2.

FIG. 4 is a sectional view schematically showing a fixing unit used for embodiment 2 of the invention.

FIG. 5 is a view in which a heat roller of the fixing unit shown in FIG. 4 is seen from the left side of FIG. 4.

FIG. 6 is a view schematically showing a heat roller of a fixing unit used for embodiment 3 of the invention.

FIG. 7 is a view schematically showing a heat roller of a fixing unit used for embodiment 4 of the invention.

Table 1 is a view showing results obtained by performing performance comparison experiments, cost evaluation and the like among a fixing unit having a basic structure of embodiment 1 of the invention, a conventional fixing unit not provided with a cleaning plate, and the like.

### DESCRIPTION OF THE EMBODIMENTS

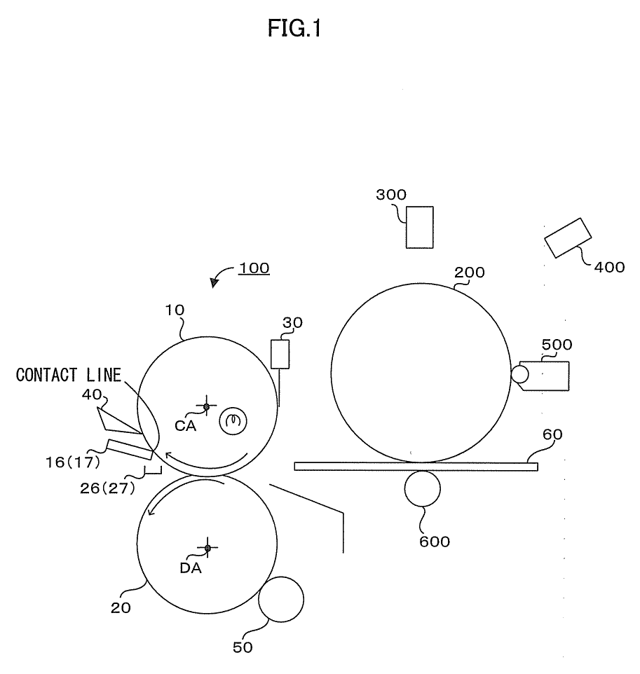

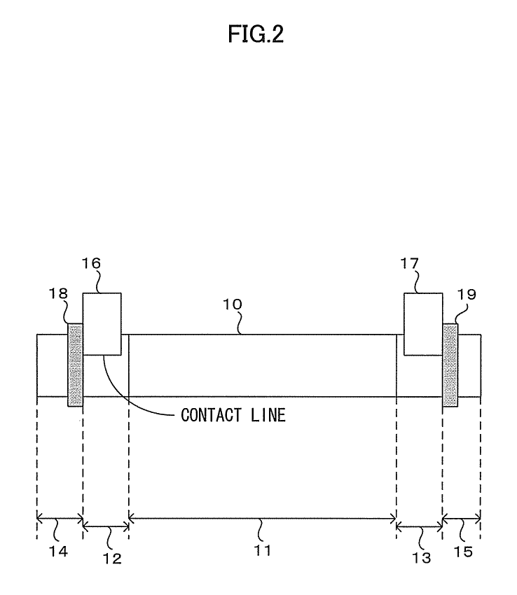

Hereinafter, embodiments of the invention will be described with reference to the drawings. FIG. 1 is a side view showing embodiment 1 of the invention, and FIG. 2 is a view in which a heat roller shown in FIG. 1 is seen from the outlet side of a print sheet.

An image forming apparatus of the embodiment of the invention includes a photoconductive body 200 as an image bearing body or an image bearing means, a charger 300 to charge the photoconductive body 200, an exposure unit 400 to expose the charged photoconductive body 200 to form a latent image, a developing unit 500 as developing means for visualizing the latent image to form a toner image, a transfer member 600 as transfer means for transferring the toner image to a print sheet 60 as a transported transfer member, and a fixing unit 100 to fix the toner image to the print sheet on which the toner image has been formed by the transfer member 600.

As the photoconductive body, an organic photoconductive body, an inorganic photoconductive body or the like is used.

As the developing unit, there is adopted a contact developing system in which a developing roller comes in contact with the surface of a photoconductive body through a developer, or a non-contact developing system in which a developer layer on a developing roller does not come in contact with the surface of a photoconductive body. Incidentally, as the developer, a one-component developer including a toner or a two-component developer including a toner and a carrier is used.

The fixing unit 100 includes a heat roller 10 as a heat member or heat means having a heater as a heat source such as a halogen lamp, cleaning plates 16 and 17 corresponding to cleaning members (cleaning means) of the invention, resin bushes 18 and 19, a press roller 20 as a press member or press means, powder collecting units 26 and 27, a temperature detection unit 30, a peeling pawl 40, and a cleaning roller 50.

The heat roller 10 and the press roller 20 of the fixing unit 100 are rotated as indicated by arrows in a state where they are in parallel contact with each other. As shown in FIG. 2, the heat roller 10 includes a paper passing area 11 at a center portion, paper non-passing areas 12 and 13 at both outsides of the paper passing area 11, and support areas 14 and 15 outside the paper non-passing areas, in which the heat roller 10 is supported by the resin bushes 18 and 19.

The press roller 20 cooperates with the heat roller 10, and causes a print sheet 60, which is sent to the paper passing area 11 of the heat roller 10 and on which a toner image is formed, to pass through (to be fed through) while pressing it against the heat roller 10, so that the toner image is fixed to the print sheet.

The temperature detector 30 (for example, thermistor) detects the temperature of the heat roller 10, sends the detected temperature data to a not-shown control unit, and enables the control unit to keep the temperature of the heat roller 10 to be on a suitable level.

In the case where the print sheet having passed through between the heat roller 10 and the press roller 20 does not normally peel off from the heat roller 10, the peeling pawl 40 peels the print sheet from the heat roller 10 in the paper passing area. The cleaning roller 50 removes a contamination on the surface of the press roller 20.

The cleaning plates 16 and 17 are rectangular heat-resistant films made of an imide-based resin such as polyimide or polyamide, and are arranged so that one sides of the outer fringes of the rectangles come in contact with the paper non-passing areas 12 and 13.

In this example, the cleaning plate 16, 17 is arranged so that a contact line in contact with the paper non-passing area 12 of the heat roller 10 is in parallel to the center axis of the heat roller 10. In that case, a free end of the cleaning plate 16, 17 is arranged to be opposite to the rotation direction of the heat roller 10.

That is, the cleaning plate 16, 17 is attached so that an angle between itself and the surface of the heat roller 10 immediately after passing through the contact line becomes an acute angle. The attachment is performed in such a direction because the efficiency of scraping is good. However, even if the attachment is performed in the opposite direction, that is, an angle between itself and the surface of the heat roller 10 immediately after passing through the contact line becomes a dull angle, although the efficiency is reduced, it is needless to say that there is an effect to a certain degree.

Immediately under the contact line where one side of the cleaning plate 16, 17 is in contact with the paper non-passing area 12 of the heat roller 10, there is provided a powder collecting unit 26, 27 to collect powder (abrasion powder; mainly produced from abrasion of the resin bush 18, 19 and flying to the paper non-passing area 12, 13) scraped by the cleaning plate 16, 17.

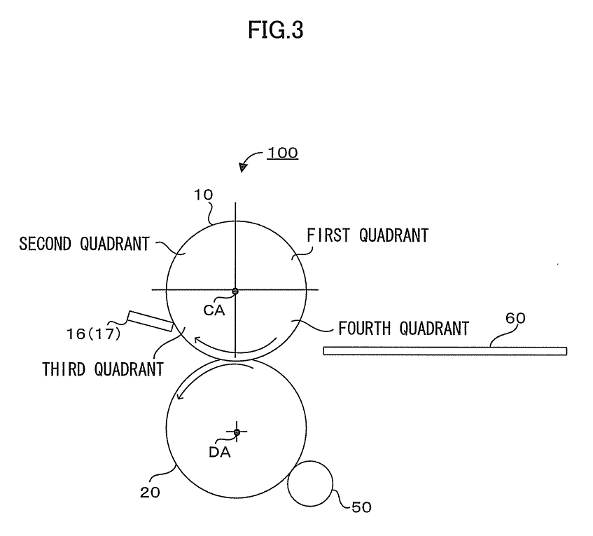

Incidentally, in this example, since the scraped powder is treated as falling according to gravity, it is preferable that the contact line of the cleaning plate 16, 17 is located in the third or fourth quadrant when a rotation center axis CA of the heat roller 10 shown in FIG. 3 is made the origin. That is, it is preferable that the contact line where the outer fringe of the cleaning plate is in contact with the surface of the heat roller 10 in the case where arrangement is made so that the rotation center axis CA becomes horizontal is located below an imaginary horizontal surface including the center axis CA of the heat roller. Especially, as shown in FIG. 3, it is preferably located in the third quadrant. This is because the scraped powder naturally falls to the powder collecting unit, and it is advantageous in preventing the powder from falling onto another member.

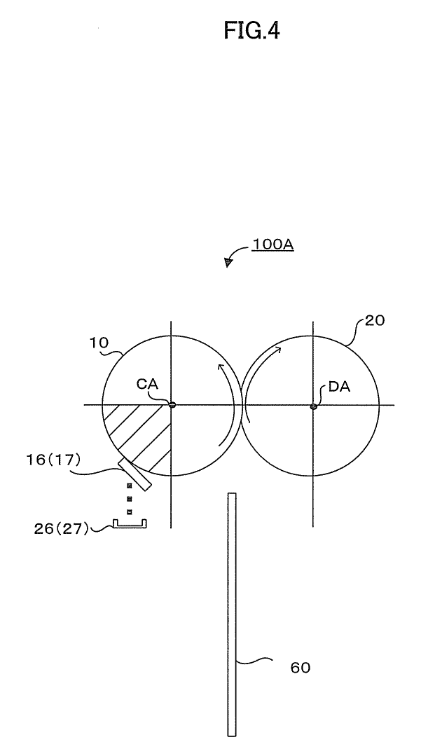

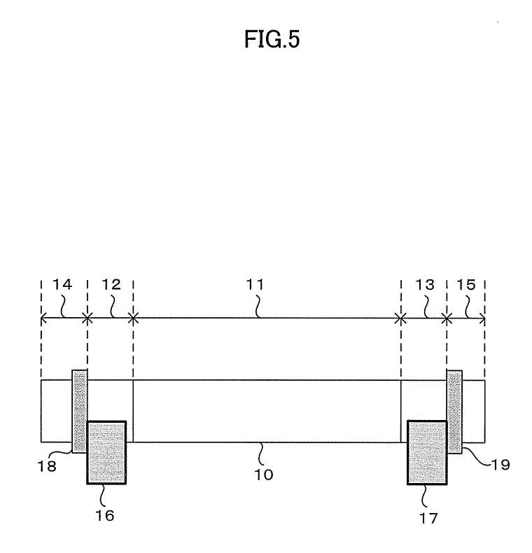

Next, embodiment 2 of the invention will be described. FIG. 4 is a sectional side view schematically showing a fixing unit of embodiment 2, and FIG. 5 is a view in which a heat roller of the fixing unit shown in FIG. 4 is seen from the left side of FIG. 4.

A fixing unit 100A shown in FIG. 4 includes a heat roller 10 and a press roller 20, and is constructed so that a print sheet 60 passes through from bottom to top.

In the case of the example of FIG. 4, a spatial allowance for the arrangement of a cleaning plate 16 (17) and a powder collecting unit 26 (27) is large. With respect to the cleaning plate 16 (17), similarly to the case of embodiment 1 shown in FIG. 1 to FIG. 3, since the scraped powder is treated as falling according to gravity, it is preferable that a contact line of the cleaning plate 16, 17 is located in the third or fourth quadrant when a rotation center axis CA of the heat roller 10 shown in FIG. 4 is made the origin. Especially, as indicated by oblique lines in FIG. 4, it is preferably located in the third quadrant. This is because the scraped powder naturally falls to the powder collecting unit, and it is advantageous in preventing the powder from falling onto another member.

Incidentally, since the rotation direction of the heat roller 10 is opposite to that in the case of embodiment 1, as shown in FIG. 5, the attachment position and direction of the cleaning plate are different.

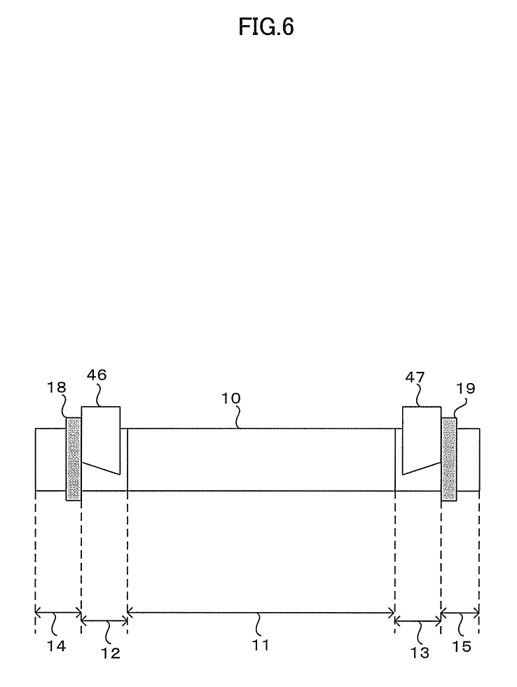

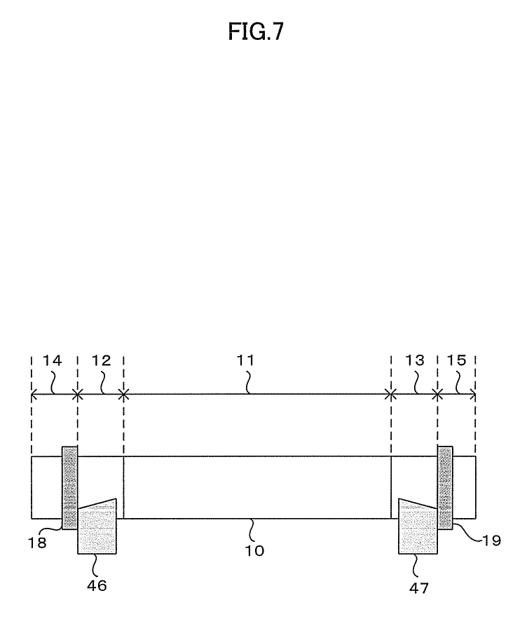

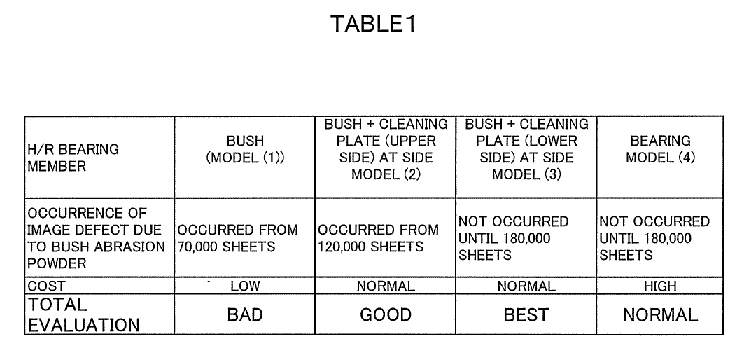

Next, embodiments 3 and 4 of the invention will be described. FIGS. 6 and 7 are views schematically showing a heat roller of a fixing unit used in embodiments 3 and 4 of an image forming apparatus of the invention. In these examples, one sides of the cleaning plates 16 and 17 used in embodiments 1 and 2 are cut obliquely, and cleaning plates 46 and 47 are formed. The cleaning plates 46 and 47 are attached so that the cut one sides are in contact with the surfaces of paper non-passing areas 12 and 13 of a heat roller 10.

In this case, since powder scraped by the cleaning plates 46 and 47 falls while moving toward the resin bush side, a possibility that a contamination flies to the paper passing area of the heat roller 10 becomes low.

Next, a description will be given to results of a performance comparison experiment and cost evaluation among a fixing unit having the basic structure of embodiment 1 of the invention, a conventional fixing unit not provided with a cleaning plate, and the like.

With respect to the fixing unit used for the experiment, a copying machine of 30 sheets of A4 size was used under conditions that the diameter of a heat roller was 430 mm (the thickness of a cored bar was 1 mm), the diameter of a press roller was 430 mm, the press force of the press roller to the heat roller was 170 N, control temperature was 180° C., and process speed was 130 mm/sec.

As comparative models in the foregoing case, with respect to bearings of the heat roller and the cleaning plate, model (1) is a conventional type using resin bushes as the bearings, model (2) uses resin bushes and cleaning plates (equal to those of embodiment 1) which are arranged at the sides of the resin bushes (in the paper non-passing areas) and above an imaginary horizontal surface including the center axis of the heat roller, model (3) uses resin bushes and cleaning plates (equal to those of embodiment 1) which are arranged at the sides of the resin bushes (in the paper non-passing areas) and below the imaginary horizontal surface including the center axis of the heat roller (herein, FIG. 1), and model (4) uses bearings instead of the resin bushes of the model (1).

When the experiment was performed under the foregoing conditions, in the respective models, print sheets of A4 size were made to continuously pass through. The results are summarized in Table 1.

Features in Table 1 indicate that in the model (1), although the cost is lowest, an image defect occurs by abrasion powder of the resin bushes at the time when the number of prints reaches 70,000, and the life is shortest. In the model (2), since abrasion powder produced from the resin bushes is scraped by the cleaning plates, as compared with the model (1) using only the resin bushes, the life can be sufficiently assured (180,000 sheets). However, when the scraped abrasion powder becomes large, since it overflows or protrudes, an image defect occurs at 120,000 sheets.

In the model (3), since the cleaning plates are disposed below the imaginary horizontal surface including the center axis of the heat roller, the scraped abrasion powder falls by its own weight and is put in a powder storage unit, and an image defect does not occur until 180,000 sheets which are the life of the bush or heat roller. In the model (4), since the bearings are used instead of the resin bush, an image defect does not occur until 180,000 sheets which are the life of the heat roller, and it is almost unnecessary to consider the life of the bearings, however, the cost is significantly increased.

In view of these, in order to prolong the life of the model (1), the model (2) and the model (3) can be carried out with a slight increase in cost, however, in view of the occurrence of the image defect, it is possible to judge that the model (3) is more excellent. When the bearings are used as in the model (4), it can be said that the quality is excessively high relative to the life. Accordingly, considering all the various factors together, it is understood that the model (3) is best. That is, it is conceivable that the model (3) in accordance with the embodiment of the invention is most effective.

In this embodiment, although the heat roller is used as the heat member or the heat means, a belt may be used. Besides, similarly, although the press roller is used as the press member or the press means, a belt or a fixed stand may be used.

As described above in detail, according to the embodiment of the invention, even if abrasion powder is produced from the resin bush with the passage of time, since the cleaning plate scrapes the incoming abrasion powder in the paper non-passing area, it is possible to prevent the abrasion powder from scattering to the paper passing area inside the paper non-passing area, and consequently, it is possible to prevent the abrasion powder from generating an image defect, and the image forming apparatus with a long life can be provided.

What is claimed is:

1. A fixing unit comprising:
a heat member that has a heater and has both ends rotatably supported by resin bushes;
a press member that cooperates with the heat member to feed a transfer member, which is sent to the heat member and on which a toner image is formed, while pressing it against the heat member and fixes the toner image to the transfer member; and
a cleaning member that comes in contact with a surface of the heat member outside an area of the heat member through which the transfer member is fed and scrapes an attachment attached on the surface of the heat member.

2. The fixing unit according to claim 1, wherein the cleaning member is plate-shaped.

3. The fixing unit according to claim 1, wherein the heat member includes a paper passing area at its center portion, paper non-passing areas at both outsides of the paper passing area, and support areas outside the paper non-passing areas in which the heat member is rotatably supported by the resin bushes, and
the cleaning member comes in contact with the surface of the heat member in the paper non-passing area.

4. The fixing unit according to claim 1, wherein a contact line where the cleaning member comes in contact with the surface of the heat member in a case of arrangement in which a rotation center axis becomes horizontal is located below an imaginary horizontal surface including the center axis of the heat member.

5. The fixing unit according to claim 4, wherein an angle between the surface of the heat member immediately after passing through the contact line of the cleaning member and a contact part of the cleaning member is an acute angle.

6. The fixing unit according to claim 1, wherein a collecting unit configured to collect the attachment scraped by the cleaning member is provided below a contact line of the cleaning member.

7. The fixing unit according to claim 3, wherein a contact line of the cleaning member is arranged in the paper non-passing area to be closer to a side of the support area than to a side of the paper passing area.

8. The fixing unit according to claim 1, wherein a contact line of the cleaning member is formed to be inclined with respect to a rotation center axis of the heat member, and the cleaning member is formed and arranged so that the scraped attachment moves to a side of the resin bush along the inclination.

9. An image forming apparatus provided with the fixing unit according to claim 1, the image forming apparatus comprising:
an image bearing body on which an electrostatic latent image is formed;
a developing unit configured to visualize the electrostatic latent image to obtain a toner image; and
a transfer member configured to transfer the toner image to a transfer member.

10. A fixing unit comprising:
heat means having a heater and both ends rotatably supported by resin bushes;
press means for fixing a toner image to a transfer member by cooperating with the heat means to feed the transfer member, which is sent to the heat means and on which the toner image is formed, while pressing it against the heat means; and
cleaning means in contact with a surface of the heat means outside an area of the heat means through which the transfer member is fed and for scraping an attachment attached on the surface of the heat means.

11. An image forming apparatus provided with the fixing unit according to claim 10, the image forming apparatus comprising:
image bearing means on which an electrostatic latent image is formed;
developing means for visualizing the electrostatic latent image to obtain a toner image; and
transfer means for transferring the toner image to a transfer member.

12. The fixing unit according to claim 10, wherein the cleaning means is plate-shaped.

13. The fixing unit according to claim 10, wherein the heat means includes a paper passing area at its center portion, paper non-passing areas at both outsides of the paper passing area, and support areas outside the paper non-passing areas in which the heat means is rotatably supported by the resin bushes, and
the cleaning means comes in contact with the surface of the heat means in the paper non-passing area.

14. The fixing unit according to claim 10, wherein a contact line where the cleaning means comes in contact with the surface of the heat means in a case of arrangement in which a rotation center axis becomes horizontal is located below an imaginary horizontal surface including the center axis of the heat member.

15. The fixing unit according to claim 14, wherein an angle between the surface of the heat means immediately after passing through the contact line of the cleaning means and a contact part of the cleaning means is an acute angle.

16. The fixing unit according to claim 10, wherein a collecting unit configured to collect the attachment scraped by the cleaning means is provided below a contact line of the cleaning means.

17. The fixing unit according to claim 13, wherein a contact line of the cleaning means is arranged in the paper non-passing area to be closer to a side of the support area than to a side of the paper passing area.

18. The fixing unit according to claim 10, wherein a contact line of the cleaning means is formed to be inclined with respect to a rotation center axis of the heat means, and the cleaning means is formed and arranged so that the scraped attachment falls while moving to a side of the resin bush along the inclination.

19. A cleaning method of a fixing unit, comprising:
rotatably supporting both ends of a heat member by resin bushes;
fixing a toner image to a transfer member by a press member that cooperates with the heat member to feed the transfer member, which is sent to the heat member and on which the toner image is formed, while pressing it against the heat member; and
scraping an attachment attached on a surface of the heat member by bringing a cleaning member into contact with the surface of the heat member outside an area of the heat member through which the transfer member is fed.
